(19) United States
(12) Patent Application Publication
(10) Pub. No.: US 2003/0050092 A1
(43) Pub. Date: Mar. 13, 2003

(54) Portable digital player--battery

(76) Inventor: Jimmy S. Yun, Boston, MA (US)

Correspondence Address: Kevin A. Buford, Holland & Knight LLP, Suite 700, 1600 Tysons Blvd., McLean, VA, 22102, US

(21) Appl. No.: 10/211,432

(22) Filed: Aug. 2, 2002

Related U.S. Application Data
(60) Provisional application No. 60/310,011, filed on Aug. 3, 2001.

(51) Int. Cl. H04M 1/00; H04B 1/38

(52) U.S. Cl. 455/556; 455/572; 455/550

(57) ABSTRACT

A portable digital player-battery includes a digital media player (e.g., an MP3 player) and a battery combined in a single device, in which the device is also designed for use as a power source (e.g., battery) for a wireless communications device like a cellular phone. The portable digital player-battery can operate as a stand-alone MP3 player when separated from the cellular phone, and when connected together with the cellular phone it can operate to stop digital media playback for the duration of a communications session.

### RELATED APPLICATION

This application is a continuation of U.S. provisional patent application No. 60/310,011 filed Aug. 3, 2001.

### FIELD OF THE INVENTION

The invention in general relates to digital audio devices, and more particularly to combination digital media players and wireless communication devices such as cell phones.

### BACKGROUND OF THE INVENTION

Cellular phones are widely used, and many users carry one with them at all times. A growing number of people also want to carry entertainment devices with them, and with the advent of digital technologies like the MP3 compression format for aural files like music, digital players like MP3 players are rapidly becoming commonplace. However, many consumers find that carrying multiple electronic devices at the same time is inconvenient. Thus, there is a need for a combined device that permits users the efficiency of a single device but also marries the digital entertainment device with a cellular phone in a convenient form.

### SUMMARY

In brief, one embodiment of the invention includes a portable digital player-battery in which a digital media player (e.g., an MP3 player) and a battery are combined in a single device, in which the device is also designed for use as a power source (e.g., battery) for a wireless communications device like a cellular phone. The portable digital player-battery can operate as a stand-alone MP3 player when separated from the cellular phone, and when connected together with the cellular phone it can optionally operate to stop digital media playback for the duration of a communications session.

A partial listing of benefits that may be realized from this embodiment include: a dual function MP3 player and cellular phone battery, able to be used solely as a MP 3 player or for powering a cellular phone; the ability to take certain information off the Internet or a memory (e.g., computer hard drive) and transform a given data into a common file that the MP3-battery will be able to translate/interpret and play back; and the capability to show text information on an LCD screen (information such as time, date, name of the song currently playing, error messages, play list, etc., and allow users to run through the play list and choose songs to play; the memory card and the power source are detachable allowing for future modifications.

### BRIEF DESCRIPTION OF THE DRAWINGS

The invention may be more readily appreciated from the following detailed description, when read in conjunction with the accompanying drawings, in which:

FIG. 1 is a perspective view of an embodiment of a digital player battery;

FIG. 2 are additional views of the digital player battery embodiment of FIG. 1, in which:

FIG. 2A is a back plan view;

FIG. 2B is a front plan view;

FIG. 2C is a left side elevational view; and

FIG. 2D is a right side elevational view;

FIG. 3A is an internal view of from the bottom side the digital player-battery embodiment of FIG. 1;

FIG. 3B is an internal view of from the top side the digital player-battery embodiment of FIG. 1; and

FIG. 4 is a perspective view of an adaptor for use with the digital player-battery embodiment of FIG. 1.

### DETAILED DESCRIPTION OF A PREFERRED EMBODIMENT

The present invention has found an efficient and convenient way to combine the benefits and features of digital media players and wireless communications devices like cell phones. The presently preferred embodiment achieves this in part by using a single power source for both the digital player and the cell phone, and combining this power source (e.g., battery) in a single unit with the digital player.

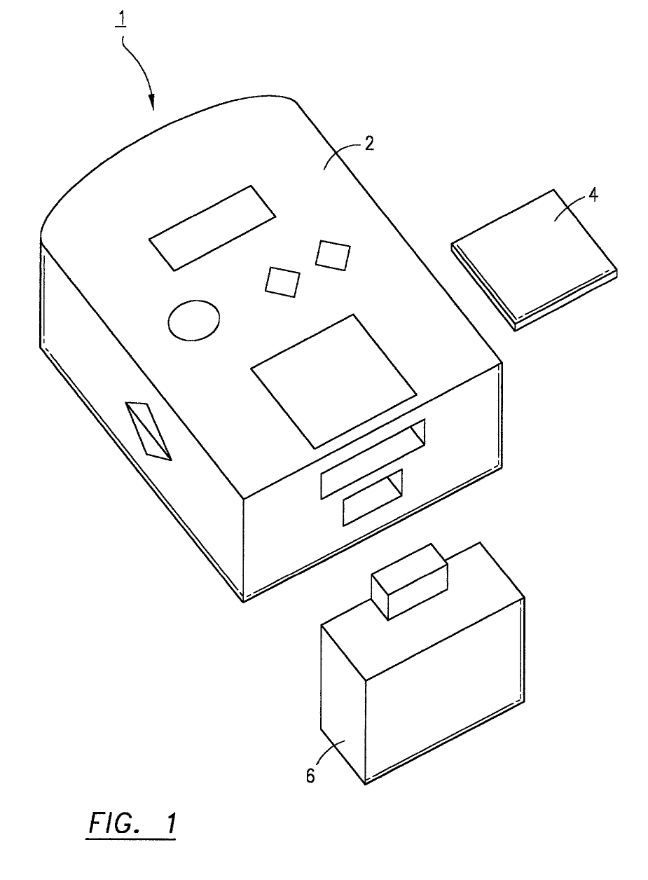

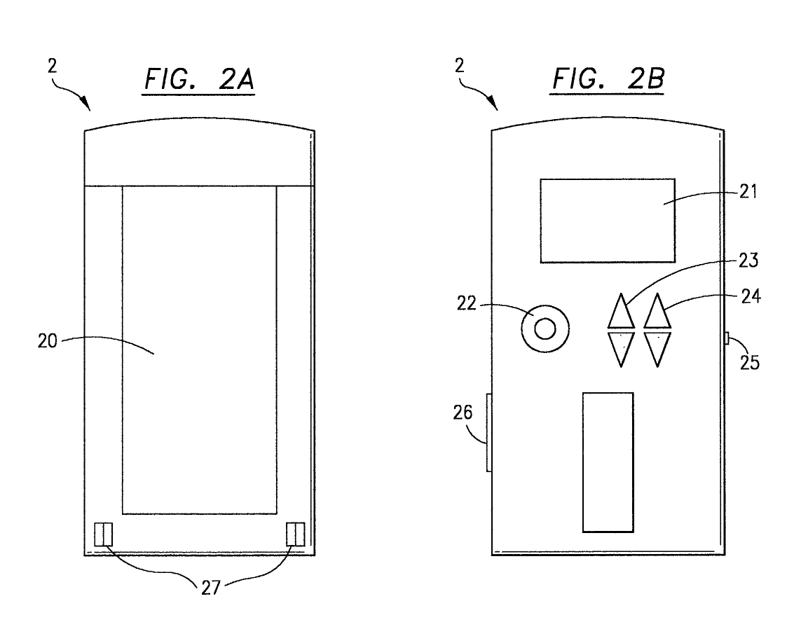

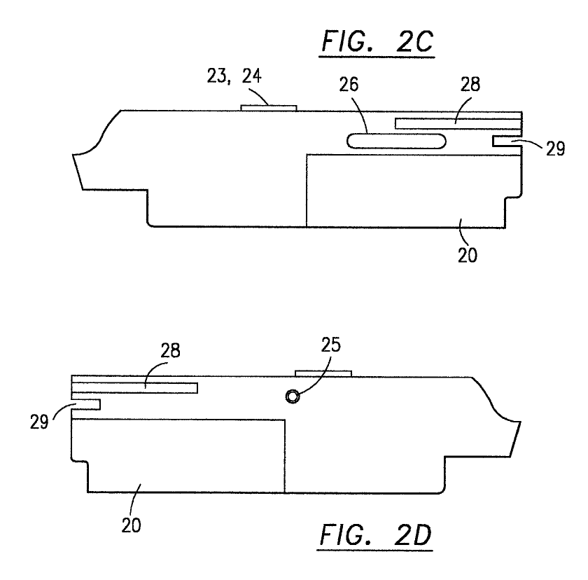

This embodiment of the invention may be better understood by reference to FIGS. 1 and 2. FIG. 1 illustrates a presently preferred digital player-battery system 1, which includes a MP3-battery device 2, a detachable memory device 4, and an external adapter 6. The digital player-battery device 2 is designed to couple with a wireless communications device like a cell phone (not shown). The memory card or store 4 can be any convenient removable means for storing digital audio (e.g., MP3) data, such as a flash memory card, that may come in any convenient size (e.g., 32 MB, 128 MB, or other appropriate storage capacity or form factor), used to provide data to the MP3 player or store limited information (e.g., song selection preferences) prompted by the MP3-battery user. The adaptor 6 may serve both as a digital audio data input/output device, as well as a power adaptor for coupling an appropriate power source to the MP3-battery 2 for purposes of recharging the battery portion of the MP3-battery 2.

This portable digital player unit 2 has the capability to playback digitally stored data that has been converted into common files (e.g., MP3 or .wav files), downloaded from any one of multiple sources (e.g., a desk-top computer, notebook, internet, etc.) via the adaptor 6 or directly to the memory 4; at the same time the MP3-battery serves the purpose of a conventional cellular phone battery. Although, the MP3-battery (e.g., a music player battery) will not only have the capacity to function as a singular operating unit with dual tasks, but may function as a separate cellular phone battery or separate MP3 unit.

The presently preferred energy source for the MP3-battery is a Lithium Ion battery, but those skilled in the art will appreciate NiMH and other rechargeable battery types may be used, depending on design choices such as compatibility with a given communication device, desired operating times and environments, etc. The battery must be capable of supporting (powering) both the cellular phone and the MP3 player. Although the power source is designed to support the cellular phone and MP3 player, it is preferable that the MP3-battery be designed so the battery is not able to support both functions simultaneously, as the presently preferred operation is to put the MP3 player on standby when the cellular phone is in use in a call. The cell phone and the MP3 player may simultaneous draw power while the cell phone is on standby.

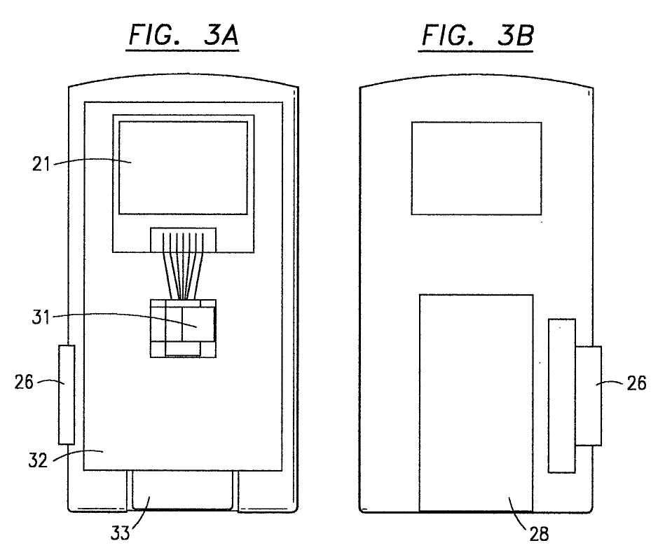

Turning now to FIG. 2A, the MP3-battery 2 is shown together with its power source (battery) 20, and connectors 27 for interfacing with connectors on a cell phone so as to provide power to the cell phone. The connectors 27 may be of any convenient shape or material, e.g., such as may be dictated by the design of the cell phone's connectors. The battery 20 is also connected to the MP3 circuitry including processor 31 (shown on FIG. 3A), and the circuitry is designed to enable power conservation by turning off MP3 functions when the cell phone is no longer in standby but is drawing power for a communication session. The battery 20 is detachable allowing for upgradeable properties in the future (e.g., for longer play/talk time).

FIG. 2B illustrates a front view of MP3-battery 2 (which in combination with the cell phone would typically be on the back of the cell phone. The MP3-battery 2 includes user interfaces such as a display (e.g., LCD) screen 21, volume and search controls 23, 24, and on-off switch 22, and an eject/hold button 26. These user interface/controls will typically control the operation of the MP3-battery apart from the functions of the cellular phone. The LCD Screen will show data in any convenient text format, and display such information that is programmed into the Memory Card as well as information entered by the user. The volume control 24 may be scroll buttons or other forms allowing the user to increase or decrease the volume of the played back data. The search control 23 (which may also be a scroll button) allows the user to scroll through the menu options, e.g., to choose the MP3 file to which he/she would like to listen. The On/Off switch turns the MP3 player on and off. The eject/hold switch is used to control certain operations, e.g., to place the MP3 player on hold, e.g., allowing the user to make or receive calls, or to eject the memory card, rendering the MP3 player unable to read and play back data. The different operations can be determined by the change in switch position, e.g., placing the MP3 Player on hold if switch 26 is moved up, or ejecting the memory card 4 if switch 26 is moved down. A skilled artisan will appreciate that other types of switches or controls may be readily used. An output connector (such as to an earphone/speaker jack) 25 is also shown by which the user may be allowed, e.g., to playback data via a headset or play back MP3 files in a car via a cassette adapter.

FIGS. 2C and 2D, respectively, are a right and left side views, respectively, of the MP3-battery 2. In addition to battery 20 and controls 23,24 and 26, these views illustrate the memory card receiving unit 28 for receiving memory card 4 and adaptor connector/slot 29 for coupling adaptor 6 to the MP3-battery 2. The memory slot 28 allows for the memory card to enter the MP3 unit, thus allowing the central processor to read the data and play back files. There may also be translation software used in conjunction with the MP3-battery, which functions to turn existing PC files into a common readable file, such that some text files can also be turned into MP3 (audio files) allowing the consumer to hear textual information; limited textual information may also be downloaded into the memory card and shown on the MP3-battery.

FIGS. 3A and 3B, respectively, are bottom and top inside views, respectively, of the MP3 battery 2. The circuitry of the MP3-battery 2 includes a processor 31 connected via a circuit board 32 and appropriate connectors to the LCD display 21, control 26, and adaptor connecter 33 (within adaptor slot 29); it is also connected to memory card receiving unit/connector 28, and battery 20. The processor allows the MP3 player to perform functions such as read, display, and play back all valid information stored onto the Memory card, and controls the other circuitry to perform the necessary tasks to read, display, play back all valid data, etc.

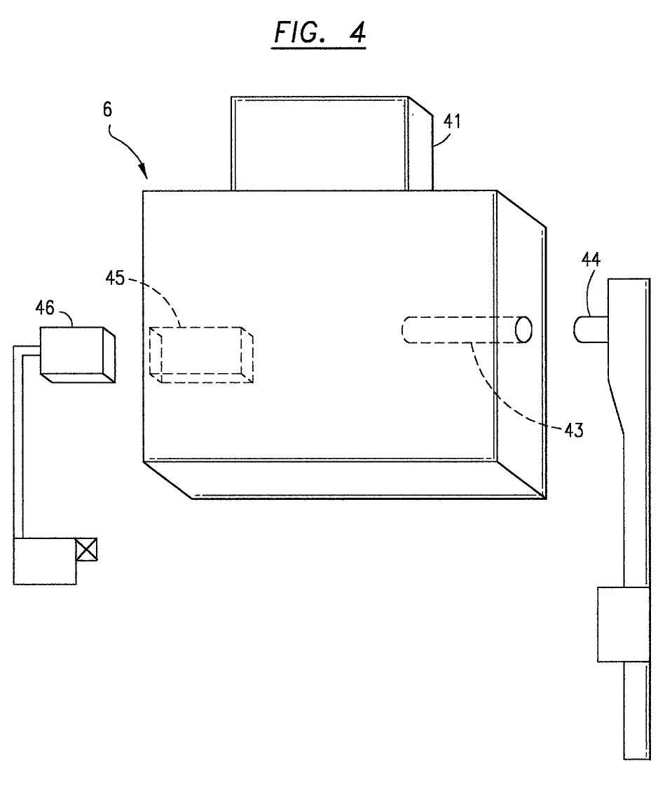

FIG. 4 illustrates a presently preferred adaptor 6. This adaptor 6 has a main port or connector 41 for coupling the adaptor 6 to the adaptor connector 33 of MP3-battery 2. The adaptor in turn has a data connector 43 which, in the preferred embodiment, is a USB adaptor for receiving a USB cable 44 connected to a source of data such as a computer. The adaptor 6 also includes a power connector or recharge port (e.g., a female receptacle 45) for receiving a power cord 46 for use in supplying power via the adapter interface 41 to recharge battery 20. The power supplied may either be AC power converted to DC (e.g., in home use) or DC power (e.g., via an appropriate car adaptor).

A separate band attachment (not shown) may be used to allow the user to wear the unit 2 on his/her body.

One skilled in the art will appreciate how numerous variations of the housing and connectors may be used. While the presently preferred embodiment uses a plastic housing, any appropriate plastic or other material may be used in making the housing and positioning the various components of the MP3-battery, depending on numerous factors such as the target consumer, the cell phone to be mated, and the like. While the presently preferred embodiment specifically discloses an MP3 player-battery for use with a cell phone, a skilled artisan will also appreciate that the invention is similarly applicable to a variety of possible digital audio players, as well as other wireless communication devices besides cell phones (e.g., cordless phones and 2-way radios). The MP3-battery is generally designed to enable any audio listener, such as a music lover to access their favorite songs, news/information (via downloads stored on the memory card) when they want without the need to carry excess hardware. The MP3-battery thus yields efficiency, enabling a consumer to perform different tasks without the need to carry an extra piece of hardware.

The MP3-battery will also be available with an additional piece of hardware allowing the unit to interface with the consumer's car either through the tape/cassette deck or through an AM/FM modulator.

The MP3-battery typically operates in such a manner that after the power source is charged, the user inserts the memory card to allow the storage of data from the individual's PC to transfer to the memory card. This transfer of data is allowed, e.g., through a software alteration creating a common file that the MP3-battery may read and play back. Once the data is stored into memory card, the MP3-battery circuitry may later analyze the data given and send text data to the LCD screen and play back the audio through the headset. The user will be able to shuffle through the stored data via the control panel (scroll switch) and increase or decrease the volume level. If the user decides to attach the MP3-battery to their cellular phone, the MP3 player will automatically switch off or can be put on hold when there is a call, e.g., notifying the user of an incoming phone call by turning off the player. If the user wishes to place a call he/she will either place the MP3player on hold or the MP3 player will automatically redirect the power source to the phone upon activation, causing the MP3 to be shut off. The user may also choose to turn off the MP3 player and use the battery function of the MP3-battery solely as a battery for the cellular phone alone. Conversely, the user may also use the MP3-battery as an MP3-player-only mode by turning off the cellular phone or detaching the MP3-battery from the cellular phone.

While the foregoing constitute certain preferred and alternative embodiments of the present invention, it is to be understood that the invention is not limited thereto and that in light of the present disclosure, various other embodiments will be apparent to persons skilled in the art. Further, while the preferred embodiment has been described in terms of a particular hardware circuitry, those skilled in the art will recognize that the MP3-battery may be made in some combination of hardware and appropriately configured programs and processors implementing the described functionality, depending on the design choices that a skilled artisan may make. Accordingly, it is to be recognized that changes can be made without departing from the scope of the invention as particularly pointed out and distinctly claimed in the appended claims which shall be construed to encompass all legal equivalents thereof.

What is claimed is:

1. A portable device capable of playing digital media and supplying power to a communications device, comprising:
a digital audio player;
a communications device battery, having connectors for providing power to the communications device when coupled via the connectors, the battery also being coupled to the digital audio player to provide power to the digital audio player, wherein the digital audio player and the battery together form a single unit.

2. The device of claim 1, further comprising:
a switch coupled between the digital audio player and the battery, operable to turn off the digital audio player for the duration of a communication session using the communications device when the communications device is coupled to the battery.

3. The device of claim 1, wherein the digital audio player is an MP3 player.

4. The device of claim 1, further comprising:
a detachable memory, operable when coupled to the digital audio player to output stored audio files for playback and information files for display via the digital audio player.

5. The device of claim 4, wherein the communications device is a cellular phone and the battery comprises a rechargeable battery suitable for use with the cellular phone.

6. The device of claim 5, further comprising an adaptor coupled to the battery and digital audio player, the adaptor comprising:
a power adaptor for coupling a power source and operable to provide power to recharge the rechargeable battery; and
an information adaptor for coupling an information source to the memory and operable to transfer information to and from the information source and the memory.

7. The device of claim 6, wherein the digital audio player is an MP3 player and the audio files are MP3 files, the device further comprising:
a processor powered by the battery and coupled to the detachable memory;
a display coupled to the processor operable to display text information from the information files; and
an audio output coupled to the processor operable to output the MP3 files from the memory.

8. The device of claim 7, wherein the processor comprises a translator for transforming the information from a first format into a second MP3 format file for playback via the audio output.

9. The device of claim 7, wherein the information adaptor is a USB connector, and the power adaptor is an AC/DC adapter.

10. The device of claim 7, further comprising a user control operable to allow a user to select MP3 files for playback and to disconnect the MP3 player on initiation of a communications session.

11. An MP3 device capable of supplying power to a cellular phone, comprising:
an MP3 player;
a battery, having connectors for providing power to the cellular phone when coupled via the connectors, the battery also being coupled to the MP3 player to provide power to the MP3 player.

12. The device of claim 11, further comprising:
a switch coupled between the MP3 player and the battery, operable to turn off the MP3 player for the duration of a communication session using the cellular phone when the cellular phone is coupled to the battery.

13. The device of claim 11, wherein the switch is operable to automatically disconnect power from the battery to the MP3 player when an incoming cellular phone call starts.

14. The device of claim 11, further comprising:
a detachable memory, operable when coupled to the MP3 player to output stored audio files for playback and information files for display via the MP3 player.

15. The device of claim 14, further comprising an adaptor coupled to the battery and MP3 player, the adaptor comprising:
an AC adaptor for coupling a power source and operable to provide power to recharge the battery; and
a USB adaptor for coupling an information source to the memory and operable to transfer information to and from the information source and the memory.

16. The device of claim 15, wherein the audio files are MP3 files, the device further comprising:
a processor powered by the battery and coupled to the detachable memory;
a display coupled to the processor operable to display text information from the information files; and
an audio output coupled to the processor operable to output the MP3 files from the memory.
